(19) United States
(12) Patent Application Publication
(10) Pub. No.: US 2014/0298184 A1
(43) Pub. Date: Oct. 2, 2014

(54) COMPUTER-IMPLEMENTED SYSTEM AND METHOD FOR INTEGRATING AND MANAGING PRODUCT SPECIFIC DATA

(71) Applicant: LARRY BAILIN, Wall, NJ (US)

(72) Inventor: LARRY BAILIN, Wall, NJ (US)

(21) Appl. No.: 13/850,796

(22) Filed: Mar. 26, 2013

(51) Int. Cl. G06F 3/0481

(52) U.S. Cl. CPC G06F 3/0481
USPC 715/738

(57) ABSTRACT

A computer-implemented method and system for integrating product data on a product website is provided. In exemplary embodiments, the method may comprise, at a client having one or more processors and memory storing one or more programs for execution by the one or more processors, displaying a user interface on the product website, the user interface comprising a plurality of tabs; receiving a tab selection indicating at least one tab of one of the plurality of tabs; retrieving product identification data; forming a query string by combining the product identification data with a search term associated with the tab selection; sending the query string to a server; receiving a list of search results from the server, wherein the list of search results is gathered by the server after running a search of the query string; and displaying the list of search results in a results window displayed over the product website.

### BACKGROUND

1. Field of the Invention

Embodiments of the present invention are generally related to computer-implemented systems and methods for integrating and managing product and service specific data. More specifically, embodiments of the present invention relate to computer-implemented systems and methods for integrating and managing product- or service-specific social media/networking data and queried search results using an on-demand web interface.

2. Description of the Related Art

Internet retailers generally strive to convert all website visitors into interested sales leads. These retailers often use specific strategies aimed at visitor conversion, including increasing the amount of time a typical visitor spends on their websites. Increasing the amount of time a visitor spends on a host/product website generally increases the likelihood the visitor will convert into an interested lead. Many visitors spend a relatively brief amount of time on product websites, however, because they often need to leave the sites to seek out product data, such as reviews and opinions on other websites. For example, a visitor to a product website may wish to seek out Google reviews, YouTube video reviews, twitter mentions, Facebook pages/groups, etc. prior to making a purchase decision. This website hopping is not ideal for internet retailers, because when a visitor leaves a host/product website, the likelihood of converting the visitor into an interested lead generally decreases. Thus, a need exists for a computer-implemented method for increasing the amount of time a visitor spends on a host/product website by reducing the need for the visitor leave the host/product website to seek out product data, thereby increasing the likelihood the visitor will be converted into an intersted lead.

### SUMMARY

Embodiments of the present disclosure relate a system and method integrating product data into a product website. In one embodiment, a computer-implemented method for integrating product data is provided comprising, at a client having one or more processors and memory storing one or more programs for execution by the one or more processors, displaying a user interface on a product website, the user interface comprising a plurality of tabs; receiving a tab selection; retrieving product identification data; forming a query string by combining the product identification data with a search term associated with the tab selection; sending the query string to a server; receiving a list of search results from the server, wherein the list of search results is gathered by the server after running a search of the query string; and displaying the list of search results in a results window displayed over the product website.

In another embodiment of the present disclosure, a computer-implemented method for integrating product data presented via a product website displayed on a client is provided and may comprise, at a server having one or more processors and memory storing one or more programs for execution by the one or more processors, sending for display by the client, a user interface on the product website, the user interface comprising a plurality of tabs; receiving a query string from the client, the query string formed by combining product identification data with a search term associated with a tab selection; sending the query string to a search server; receiving a list of search results from the search server, wherein the list of search results is gathered by the search server after running a search of the query string; and sending the list of search results to the client for display in a results window displayed over the product website.

In yet another embodiment of the present disclosure, a system is provided that may comprise at least one server, the server comprising one or more processors; and memory; wherein the at least one server is configured to send for display by a client, a user interface on a product website, the user interface comprising a plurality of tabs; receive a query string from the client, the query string formed by combining product identification data with a search term associated with a tab selection; send the query string to a search server; receive a list of search results from the search server, wherein the list of search results is gathered by the search server after running a search of the query string; and send the list of search results to the client for display in a results window displayed over the product website.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a system-level network diagram of a system for integrating and managing product specific data on a product website in accordance with embodiments of the present disclosure;

FIG. 2 depicts a block diagram of a general computer system, which is capable of being used in connection with the system depicted in FIG. 1, in accordance with embodiments of the present disclosure;

FIG. 3 depicts a block diagram of a social persuasion engine (SPE) in accordance with embodiments of the present disclosure;

FIG. 4 depicts an exemplary client computer capable of being used with the system depicted in FIG. 1, in accordance with embodiments of the present disclosure;

FIG. 5 depicts an exemplary user interface for display by a client in accordance with embodiments of the present disclosure;

FIG. 6 depicts an exemplary user interface in accordance with embodiments of the present disclosure;

FIG. 7 depicts an exemplary client computer displaying a results window in accordance with embodiments of the present disclosure; and

FIG. 8 depicts a flow diagram illustrating an exemplary method for integrating and managing product specific data on a product website in accordance with embodiments of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to computer-implemented systems and methods for integrating and managing product and service specific data. More specifically, embodiments of the present invention relate to computer-implemented systems and methods for integrating and managing product- or service-specific social media/networking data and queried search results using an on-demand web interface.

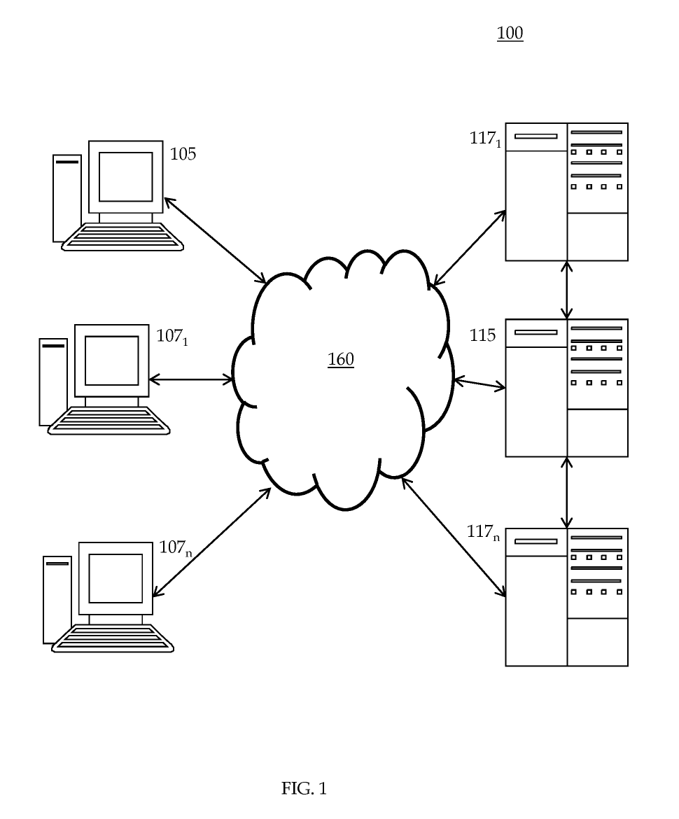

FIG. 1 depicts a system-level network diagram of a system 100 for integrating and managing product specific data on a product website in accordance with embodiments of the present disclosure. The system 100 generally comprises at least a first client 105, generally in communication with a server 115 via a network 160. In some embodiments, the system 100 may comprise secondary clients 107₁ and 107ₙ. The clients may be in communication with the host server 115, generally through the network 160.

Methods in accordance with embodiments of the present disclosure may take place over the network 160, which may comprise a global computer network, for example, the internet. The communications functions described herein can be accomplished using any kind of wired and/or wireless computing network or communications means capable of transmitting data or signals, such as a wireless and/or wired computing network allowing communication via, for example, an 802.11 (“Wi-Fi”) protocol, cellular data protocol (e.g., EDGE, CDMA, TDMA, GSM, LTE), and/or the like. Suitable examples include a packet-switched network, a local area network (LAN), wide area network (WAN), virtual private network (VPN), or any other means of transferring data. The network 160 may be a partial or full deployment of most any communication/computer network or link, including any of, any multiple of, any combination of or any combination of multiples of a public or private, terrestrial wireless or satellite, and wireline networks or links. A single network 160 or multiple networks (not shown) that are communicatively coupled to one another can be used. It is contemplated that multiple networks of varying types can be connected together and utilized to facilitate the communications contemplated by the systems and elements described in this disclosure.

Although FIG. 1 depicts two secondary clients 107₁ and 107n, it should be appreciated that “n” represents any number of clients feasible in accordance with embodiments of the present disclosure. For ease of reference, as used herein, the term “client” may refer to any one or all of the clients, 105, 107₁, and 107ₙ, within the system 100. That is, in certain embodiments, multiple clients may perform the same or similar functions. For ease, one client 105 will be referred to herein, however in exemplary embodiments, more than one client 105 may be included in the system 100. Although many embodiments described herein are described with reference to a “product” website offering a product for sale, the systems and methods described herein may also be performed in conjunction with a “service” website offering a service for sale, or a combination thereof.

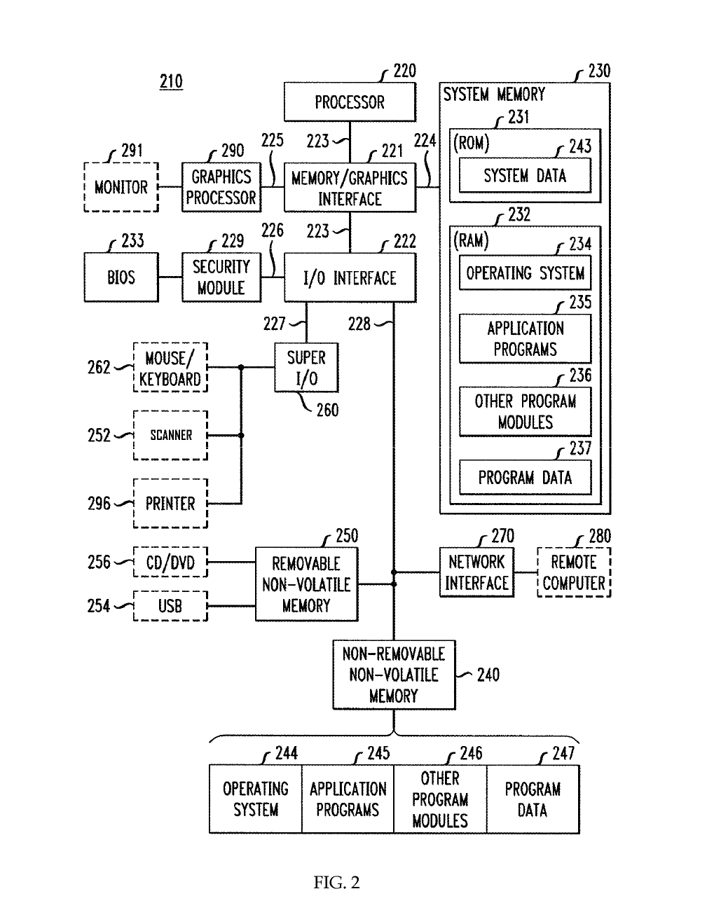

As used herein, the term “computer” may generally refer to any device that is capable of processing a signal or other information. Examples of computers include, without limitation, a personal computer, a portable computer, a handheld computer, a cellular phone, a smart phone, a digital tablet, a laptop computer, a netbook, an Internet appliance, a Personal Data Assistant (PDA), an application-specific integrated circuit (ASIC), a programmable logic array (PLA), a microcontroller, a digital logic controller, a digital signal processor (DSP), or the like, or may generally include a general purpose computer, as discussed below with respect to FIG. 2. A computer may include software in the form of programmable code, micro code, and or firmware or other hardware embedded logic and may include multiple processors which operate in parallel. The processing performed by a computer may be distributed among multiple separate devices, and the term computer encompasses all such devices when configured to perform in accordance with the disclosed embodiments.

The client 105 may generally comprise a communications device, such as a computer. In a basic exemplary embodiment, within the system 100, the client 105 may be capable of transmitting data to and from a host server 115. The host server 115 may host an accessible data portal (e.g., a website or the like). The accessible data portal, which may be accessible to the client 105, may communicate with the client 105 through the network 160. The accessible data portal may comprise any number of security measures to provide a reasonably secure system, suitable for embodiments of the present disclosure. The accessible data portal may further comprise a graphical client interface (GUI) through which a client 105 may access the server 115.

The system may also comprise secondary servers 117₁ and 117ₙ. Although two secondary servers 117₁ and 117ₙ are depicted in FIG. 1, it should be appreciated that “n” represents any number of servers feasible in accordance with embodiments of the present disclosure. For ease of reference, as used herein, the term “server” may refer to any one or all of the servers, 115, 117₁, and 117ₙ within the system 100. That is, in certain embodiments, multiple servers may perform the same or similar functions.

The server 115 may also comprise a database or other sortable data storage memory to enable the system and methods disclosed herein. In many embodiments, the database may be any commercially available data storage database suitable for embodiments of the present disclosure. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a first client 105, wherein a plurality of client-specific data is stored. The database may also include any number of subsequent data sets representing N clients, wherein N represents any number of clients practical for operation of embodiments of the present disclosure. In accordance with one embodiment of the present disclosure, any of the servers or clients may comprise a general purpose computer, for example, as shown in the form of a computer 210 depicted in FIG. 2.

FIG. 2 depicts a block diagram of a general computer system, which is capable of being used in connection with the system depicted in FIG. 1, in accordance with embodiments of the present disclosure. As appreciated by embodiments of the present disclosure, mobile devices, such as mobile telephones, tablets, netbooks, or the like, may be utilized instead a general computer 210 for embodiments of the present disclosure. However, it is also appreciated there is a significant similarity in core components between a mobile device and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identification information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up. In some embodiments, a security module 229 may be incorporated to manage metering, billing, and enforcement of policies. The security module 229 may comprise any known security technology suitable for embodiments disclosed herein.

A super input/output chip 260 may be used to connect to a number of peripherals, such as a scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace. In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A client may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet. In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present disclosure, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure.

It is understood by embodiments of the present disclosure that a computer, such as the one depicted in FIG. 2, may be connected to a computer network or system. A computer network may include the Internet, a global computer network, an internal computer network, dedicated server networks, or the like.

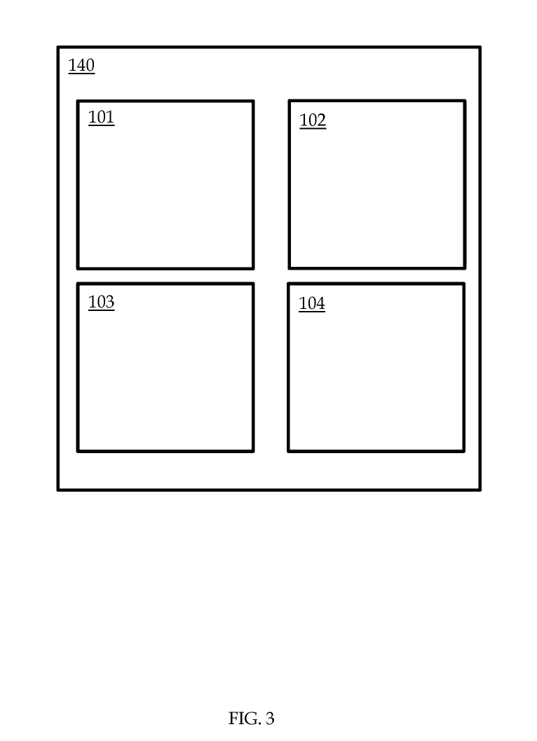

FIG. 3 depicts a block diagram of a social persuasion engine (SPE) 140 in accordance with embodiments of the present disclosure. The SPE 140 may generally comprise computer executable software and/or instructions configured to perform the functionality of the systems and methods disclosed herein. The SPE 140 may comprise a host interface 101, a user interface 102, a super-admin interface (SAI) 103, and/or an analytics and reporting module 104. In exemplary embodiments, the SPE 140 may be configured to optimize converting website visitors into interested leads by increasing the likelihood that a visitor will spend a greater amount of time on a SPE-enabled product website. The SPE 140 may be configured to provide real-time or substantially real-time search and social media data to the visitors, thereby increasing the likelihood of the visitors making contact and converting into interested leads. The SPE 140 may generally comprise a managed content delivery system designed to provide website visitors with a more robust website experience.

In exemplary embodiments, the SPE may 140 be configured to perform a search for specified content and/or elements on a website and automatically capture the specified content and to be used in a query string for sending to various social and search platforms across the web, returning real-time or substantially real-time information, data, videos, reviews, or the like, and other results about the product. By way of example, the SPE 140 may be configured to search for a product name or vehicle type and append a predetermined search term, such as “reviews” and form a query string. The SPE 140 may be further configured to perform a search of the query string and return appropriate search results data. Once the appropriate data is retrieved, it may be displayed to a user in a simple, easy to use user interface 102 which may allow a user to view and interact with valuable information about a specific product they are interested in without leaving the originating/host website. The SPE 140 can be used on any website via a code-based widget. Further, SPE 140 can be used to enhance content with real-time search and social data and improve conversion of visitors to leads for any product.

The SAI 103 may be configured to allow a user with administrative system access, i.e., a Super-Admin (SA), to set-up the SPE 140. In exemplary embodiments, the SAI 103 may comprise browser based installer tool allows a SA to setup a widget for deployment. The SAI 130 may act as a builder, where the SA can setup multiple parameters based on details and elements originating from the host website. Once specific host data is entered the SAI 103 may be configured to assemble the proper HTML embed code to be placed on the host website. In exemplary embodiments, the SAI 103 may be configured to allow for the setup and management of user host data by the SA. Some examples of options that may be configurable by the SA by using the SAI 103 may include: name/company, URL of host website, industry of host website, date the widget was activated on host site, activate and suspend function with indicator of status, edit and delete user functions, edit widget parameters function, product parameters, social/search platforms, number of results returned, colors/templates, host logo upload/delete (host logo displayed on a results popup page), data filtering, URL filter, keywords filter, and access to the functions of the analytics and reporting module 104.

The name/company option may generally be adapted to receive the name/company of the entity hosting the website. For example, the name/company option may comprise a text field adapted to receive the text of a company name or the like. Similarly, the URL of the host website option may be adapted to receive a URL name, the industry of the host website option may be adapted to receive an industry name, the date the widget was activated on the host site option may be adapted to receive a date or be automatically populated by the date the widget was activated, and the number of results returned option may be adapted to receive a number of results. Any of the options presented herein may also be preconfigured and selectable, for example, by way of a drop down list, radio buttons, and/or the like. The activate and suspend function/option may generally be configured to allow the SA to activate and/or suspend one or more functions of the SPE 140. The indicator of the status function/option may be adapted to indicate if the SPE 140 is activated or suspended. The edit and delete user function option may be adapted to edit the access restrictions of a particular user of the SPE 140. The edit widget parameters function/option may be adapted to allow the SA to modify the size of the dimensions and/or the general appearance of the widget. The product parameters may comprise a listing of product parameters about a specific product website. For example, the product parameters option may comprise the make, model, year of manufacture, or the like of a product. The social/search platforms option may be configured to allow the SA to configure the specific search engine options that will be presented to the user in user interface 102. The colors/templates option may allow the SA to configure the appearance of the user interface 102. The host logo upload/delete option may be configured to allow the SA to upload a logo of the entity that owns the website for inclusion in the search results of the user interface 102. The filtering functions may generally be configured to allow the SA to enable and/or disable certain textual filtering to be completed by a user and/or SA. The analytics module configuration option may be configured to allow the SA to configure the parameters and/or format of analytical reports.

In addition to the SAI 103, the SPE 140 may also comprise a host interface 101 configured to allow a user to customize an SPE 140 widget. The host interface 101 may generally comprise a browser based administrative control panel that is provided to the website owner/host, for allowing the customization of the widget and its functions, such as favorites tab administration (adapted to allow an administrator to select their favorite video(s) to be displayed on a separate tab) and analytics (adapted to allow access to user specific reports related to widget usage on the host website).

In exemplary embodiments, the SPE 140 may also comprise an analytics and reporting module 104. The analytics and reporting module 104 may generally be configured to provide administrative reports associated with the host website. In exemplary embodiments, the administrative reports may comprise the following data: the number of times the widget has been displayed (impressions), the number of times the widget is used (per day, week, month) with up to twelve months-worth of monthly data, the top products researched, and the amount of time spend using widget (per visitor). The analytics and reporting module 104 may also be configured to provide global reports and trends. The global reports and trends may generally only be accessible by the SA. In exemplary embodiments, the global reports and trends may include top products researched by industry, including a drilldown of top social/search properties by product, top products researched globally, top social/search properties by industry, top social/search properties globally. The analytics and reporting module 104 may also be configured to provide impressions report (including a drilldown to industry and product), a geography report (including a drilldown industry, products, impressions, and time spent), and a time spent report (including a drilldown to industry, product, globally, and geography). Such analytics may also include product trend information, user trend by demographic, etc.

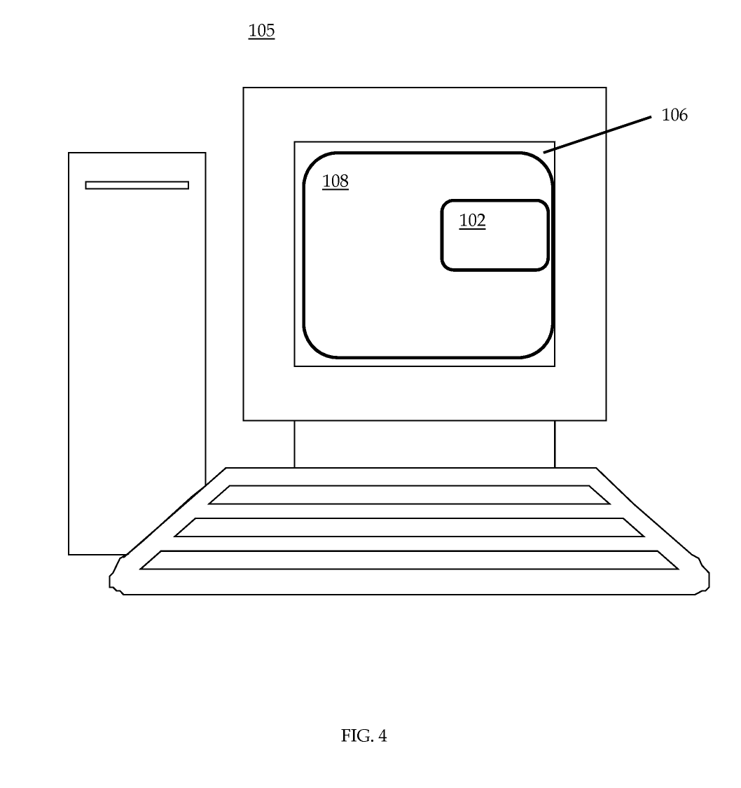

In exemplary embodiments, the SPE 140 may also comprise a user interface 102. The user interface 102 may generally comprise a public facing interface. An exemplary user interface 102 in accordance with embodiments of the present disclosure is depicted in FIGS. 4-7. The user interface 102 is described in more detail below, in the descriptions of FIGS. 4-7. The SPE 140 is generally configured to work on any website. To install the SPE 140, a line of code, HTML code, for example, is placed on the desired page, or source code, or header, or other location of the website. The code allows a Widget and/or user interface 102 to be displayed to the user. The user interface 102 contains all of the search and social interaction points as well as visuals to engage the visitor. The user interface 102 may generally comprise a graphical interface allowing a user to easily select the data they want to view.

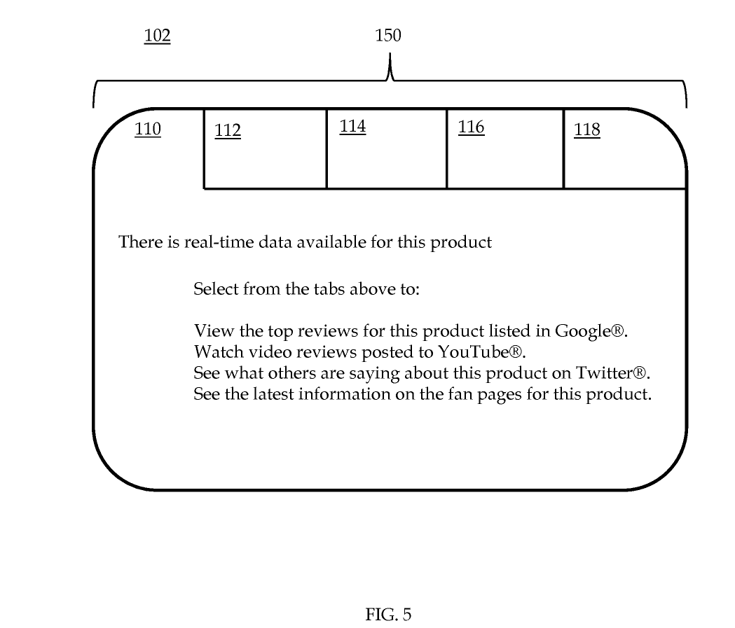

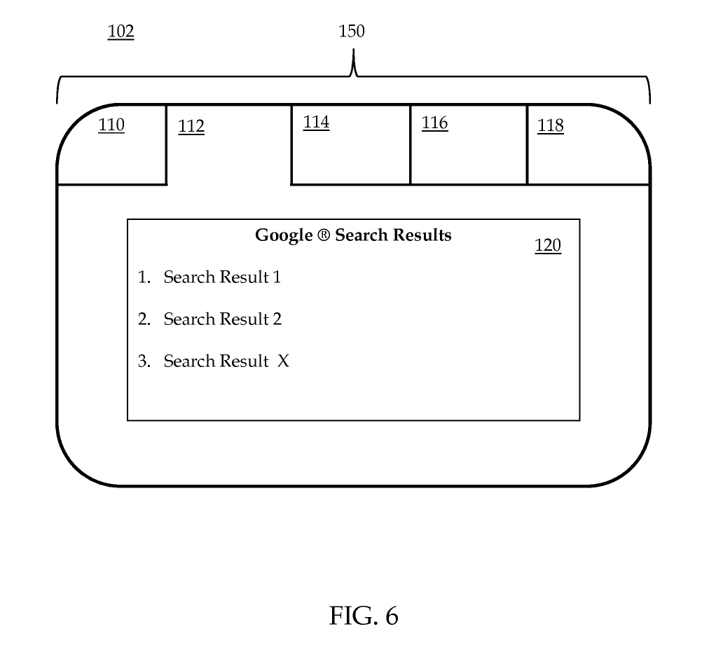

FIG. 4 depicts an exemplary client 105 capable of being used with the system depicted in FIG. 1, in accordance with embodiments of the present disclosure. In exemplary embodiments, the client computer 105 may comprise a display 106. The display 106 may be adapted to display at least a product website 108 and a user interface 102. In exemplary embodiments, a product website 108 may comprise a passive website, e.g., a website adapted to display product information but not to receive and process product sales, or an active website, i.e. a website adapted to receive and process product sales. The user interface 102 may be displayed in any location on the display 106 of the client 105 or the like. For example, adjacent the product website 108, in-front of the product website 108, or in alternative locations consistent with the present disclosure. An exemplary user interface 102 is depicted in FIGS. 5 and 6.

FIG. 5 depicts an exemplary user interface 102 for display by a client 105 in accordance with embodiments of the present disclosure. In exemplary embodiments, the user interface 102 may be displayed on a product website 108 and may comprise a plurality of tabs 150. Although shown as a “tab,” embodiments of the present invention appreciate the “tab” may take on the form of any selectable portion of the user interface, whether or not a traditional “tab” appearance is present.

One or more tabs of the plurality of tabs 105 may be configured engage a user to select, manage, view, or the like, enhanced product data. Although the user interface 102 is depicted as having a specific shape and tab configuration in FIGS. 5 and 6, any tab configuration and/or shape of the user interface 102 consistent with embodiments of the present disclosure is contemplated. For example, the user interface 102 may comprise a circle, triangle, alternative shape, or the like, and/or the tabs may be disposed on the top, bottom, left, right, or any feasible location on the interface 102. In addition, more than one tab may be displayed simultaneously, and may comprise branding information of the host website. For example, branding information, such as company name, logo, animations, colors, and/or trademark data and representations, may be displayed on or near the user interface 102. Although five tabs 110, 112, 114, 116, and 118 are depicted in the figures, any number of tabs consistent with the present disclosure is contemplated.

In exemplary embodiments, the plurality of tabs 150 may comprise a first tab 110 having a status message portion displayed thereon. In exemplary embodiments, the first tab or initial tab may comprise a resting point for the user interface 102/widget that may be configured to engage the user by displaying information and/or a status message that may include animated graphics, when there is data related to the assigned product. The status message portion may be adapted to display a status message indicating there is data available for a product listed on a product website 108. In exemplary embodiments, the message may comprise text, audio, video, animation, or the like, or any indicator adapted to alert a user that product data is available. The SPE 140 may be adapted to determine data is available by performing a preliminary search in the same manner a search is performed after a user selects one tab of the plurality of tabs 150, in a process described below. Although a specific text message is depicted in the first tab 110 in FIG. 5, the status message is not limited to the text message depicted. Alternative text, animation, pictures, videos, color symbols, shapes, or the like may be used. It will be appreciated that any indication that product data is available consistent with embodiments of the present disclosure is contemplated. In alternative embodiments, a status message portion may not be included on any tab and each of the plurality of tabs 150 may comprise search tabs adapted to allow the user to conduct a search of product data.

When a preliminary search is conducted, the search may be performed by the SPE after capturing product data on the product website 108 and combining it with one or more search terms associated with at least one of the plurality of tabs 150. Each of the plurality of tabs 150 may generally be associated with a search term. The SPE 140 may be adapted to combine product data with the search term to form a query string, send the query string to a search server and/or other searchable means, and receive search results. Search results may generally comprise social media product data, social networking product data, and general product mentions, or the like. For example, the search results may comprise video reviews, Twitter mentions, Facebook Reviews, general website reviews, general internet mentions, and internet product groups and may generally be gathered in real-time or substantially in real-time. Alternatively, the search results may comprise custom data points (e.g., unique third party postings, dealer ratings, etc.)

In exemplary embodiments, the first tab 110 may comprise a message indicating there is product data available and directing the user to select another tab. The first tab 110 may generally include a listing of only relevant tabs, that is, only tabs that have returned relevant search results. In exemplary embodiments, the user interface 102 may be configured to display real-time product data to a user as they select a tab. The tab selection may generally be made by mouse click or by other feasible means, such as a touch-screen depression where the selected tab is displayed on a touch-screen. Each tab of the plurality of tabs 150 may be adapted to return search results from a selected source and/or searchable means, for example, a search engine, social network, or the like. The sources and/or searchable means may be predetermined or selected by the SA.

The SPE 140 may be adapted to automatically select an appropriate product identification data to capture and query. The SPE 140 may be configured to query the product identification data and a specified search term and return the appropriate data and/or search results related to the element product to the user. The user interface 102 may be configured to allow a user to access the SPE 140 and/or display the search results. In exemplary embodiments, the SPE may be adapted to determine that product data is available after performing a preliminary search when a user accesses a product website 108 and prior to the user selecting any of the plurality of tabs 150. In alternative embodiments, a search may not be conducted until after the user selects at least one tab of the plurality of tabs 150. The preliminary search may be conducted for every tab of the plurality of tabs 150 or a selected tab or group of tabs. The preliminary search conducted by the SPE 140 and the search conducted when a user selects a tab may be generally similar, and differ only in the way in which the search is initiated. If a preliminary search is conducted, the search is initiated when a user accesses a product website 108 and all tabs or selected tabs of the plurality of tabs 150 are searched.

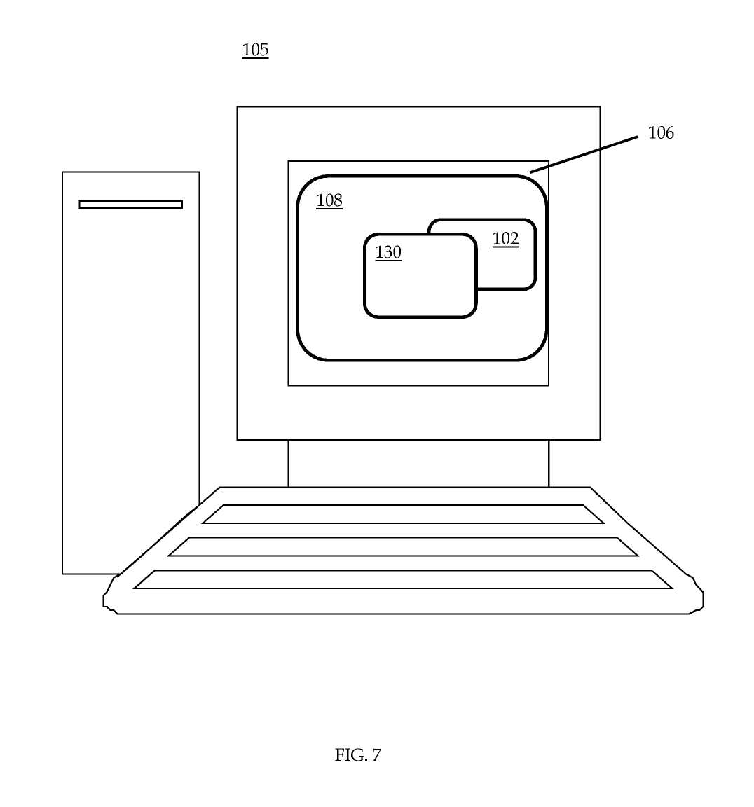

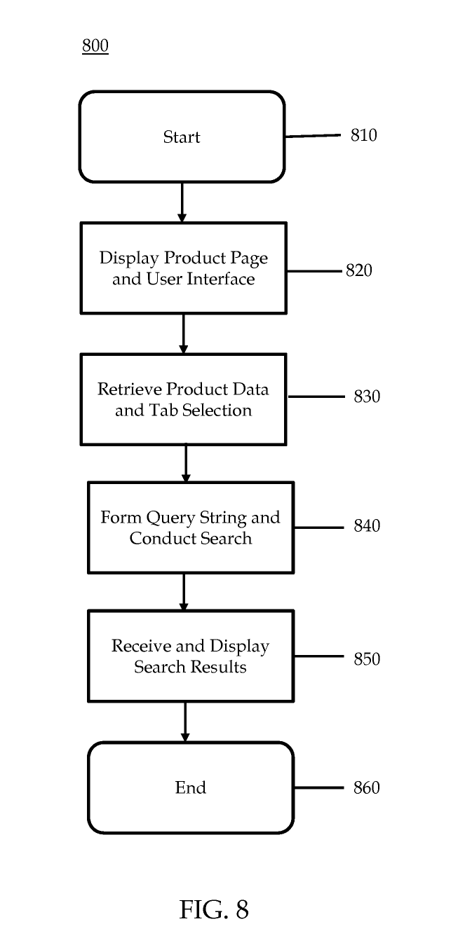

If a preliminary search is not conducted, the search is initiated when a user selects a tab and the client 105 receives a tab selection. A tab selection may be received by the client 105 when the user selects one of the tabs by an input communicatively coupled with the client 105. For example, the user may select a tab by mouse click, touch screen selection, keyboard selection, voice indication, or the like, and an indication may be sent to the client 105. The indication may comprise an indication by the user consistent with embodiments of the present disclosure for selecting at least one tab of the plurality of tabs 150. After the indication is received, the search may be initiated. In exemplary embodiments, after the search is initiated, the search may be performed and a list of search results may be returned. Exemplary embodiments of searches performed in accordance with the present disclosure are described in more detail with reference to FIG. 8. After the list of search results is returned, it may be displayed in the selected tab, as depicted in in FIG. 6 or in a pop-up display, as depicted in FIG. 7.

FIG. 6 depicts an exemplary user interface 102 in accordance with embodiments of the present disclosure. The user interface 102 and plurality of tabs 150 are generally described with reference to FIG. 5. In exemplary embodiments, after a list of search results are returned, they may be displayed in a results tab display 120 displayed on a tab, for example, a second tab 112. The results tab display 120 may generally be configured to display search results associated with a tab selection. For example, if the second tab 112 is associated with the Google search engine, when the second tab 112 is selected by the user, a search of the Google search engine may be performed and a list of search results may be returned and displayed in the results tab display 120 of the second tab 112 of the plurality of tabs. Although Google search results are displayed in FIG. 6, results from any website, database, searchable means, or the like consistent with the present disclosure is contemplated. The search results list may be presented in a text list, as depicted in FIG. 6, and may comprise hyperlinks to specific search results. For example, if a search of the Google search engine returned a first result presented in the search results list, a hyperlink to the first search result may be displayed in the results tab display 120.

In addition to the Google search engine, alternative and/or additional websites/databases may be searched. By way of example, Google review search results may be displayed by selecting a second tab 112, YouTube video reviews may be displayed by selecting a third tab 114, Twitter mentions may be presented in a fourth tab 116, current Facebook pages/groups related to the product may be displayed in a fifth tab 118. The user interface 102 may be adapted to display the most relevant results related to the product identification data returned from one or more websites and/or databases. The search results may be displayed on one of the plurality of tabs 150 themselves, or may be displayed in a new process/window that may be configured to “pop up” in front of the product website 108. The user interface 102 may also be adapted to display a favorites tab (not shown) adapted to display a mix of specific videos selected/created by the host and/or SA to be displayed to a visitor. The SA can assign a specific view state to all content to be presented via the user interface 102 and or the results window display 130. For example, the SA may configure a specific video/review to be viewed with all products or viewed with selected products on specific product websites 108. When a website selects and/or access a hyperlink presented in the results list, the specific search results may be displayed in the search tab display 120, or may be displayed in a pop up results window display, as depicted in FIG. 7.

FIG. 7 depicts an exemplary client 105 displaying a results window 130 in accordance with embodiments of the present disclosure. The user interface 102, display 106, and product website 108 are generally described above with respect to FIG. 4. In exemplary embodiments, the results window 130 may be adapted to display a list of search results. The results window 130 may comprise a pop-up display and may comprise a means of closing the window, such as a close button to return the user to a larger viewable portion of the product website 108. The results window 130 may be adapted to be displayed over the product website 108 or adjacent the product website 108, or any location consistent with the present disclosure. The results window display 130 may comprise a separate browser window, or may comprise a pop-up, displayed in the same browser window as the product website 108. The methods for returning the search results list to be displayed in the results window display and/or the user interface 102 is described with respect to FIG. 8.

FIG. 8 depicts a flow diagram illustrating an exemplary method 800 for integrating and managing product specific data on a product website in accordance with embodiments of the present disclosure. In exemplary embodiments, the computer-implemented method 800 may comprise integrating information from search engines and social networks to be displayed via web browser on any website. The method 800 may be carried out using the architecture and components described in the systems above, or may utilize any other type of system architecture suitable for embodiments of the present disclosure. It should further be appreciated, the steps of method 800 may be carried out in any order (e.g., step 830 may occur before step 820), unless otherwise explicitly specified by the steps of the exemplary method. For ease, exemplary methods represented in FIG. 8 are described with reference to the client 105, server 115, SPE 140, and user interface 102 described above with respect to FIGS. 1-7. The method 800 may be carried out using other embodiments as well. Many steps of the method 800 may generally be carried out by the SPE 140. The SPE 140 may be stored on a client 105, a server 115, or any other data storage location consistent with the present disclosure. It will be appreciated that the steps of the method 800 may be performed exclusively on the client 105 or partially on the client 105 and partially on the server 115. Any combination of shared computing power for performing the steps of the methods described herein consistent with the present disclosure is contemplated. For example, multiple clients 105 and servers 115 may collaborate to perform the steps of method 800. Although many of the steps are described below as being performed on a client 105, other elements of the system 100 or combination of elements may perform the steps as well.

The method 800 begins at step 810. At step 820, client 105 is provided and a product website 108 and a social interface 102 are presented for display on a display 106. The client 105 may comprise one or more processors and memory storing one or more programs, such as the SPE 140. The client 105 may comprise any number of security measures to provide a reasonably secure system, suitable for embodiments of the present disclosure. The SPE 140 may be configured to display the user interface 102 on and/or near a product website 108 on the display 106. The user interface 102 may generally comprise a plurality of tabs 150. The plurality of tabs 150 may comprise a first tab 110 and a second tab 112. The first tab 110 may comprise a status indicator for indicating whether product data is available. The second tab 112 may comprise a search results tab for initiating a search and/or displaying a list of search results. At least one tab of the plurality of tabs 150 may be selectable by a user of the SPE 140 for initiation of a search for product data. The at least one tab may be selectable by input received by the user, for example, a mouse click indication or a touch screen selection, or any other means of receiving a tab selection by a user consistent with the present disclosure.

At step 830, product identification data may be retrieved and a tab selection may be received by the SPE 140. The tab may be selected by the user using the methods described above. In alternative embodiments, the tab may be preselected by an SA or a user and a preliminary search may be conducted for indicating whether relevant product data exists. When the at least one tab is selected by the user or pre-selected, a search may be initiated by retrieving product identification data. The product identification data may be retrieved by searching the product website 108. For example, the product identification data may be retrieved by performing a text search of the product website 108 and locating the product identification data by comparing the text of the product website to a database of recognized product identification terms. When a match between a portion of the text of the product website 108 and at least one of the recognized product identification terms occurs, the matching portion may be designated as product identification data by the SPE 140. The product identification data may comprise data that may identify a product. For example, the product identification data may comprise at least one of a manufacturer name, a model name, and a year of manufacture, such as “Chrysler,” “LeBaron,” and “1989.” After the product data and tab selection are collected, a query string may be formed.

At step 840, a query string may be formed and a search of the query string may be conducted. In exemplary embodiments, the query string may be formed by combining the product identification data with a search term associated with the tab selection. The search term associated with the tab selection may be preconfigured by the SA, and may comprise a term associated with a specific searchable means. The searchable means may comprise, a search engine, a search server, a searchable database, a data repository, or the like. For example, a searchable means may comprise a search engine (e.g., the Google, Yahoo!, MSN search engines, or the like), a social media website (e.g., YouTube, or the like), or a social networking website (e.g., Facebook, LinkedIn, Twitter, or the like). By way of example, a specific search term, such as “reviews” may be appended to the product identification data and sent to the searchable means by the SPE 140. In exemplary embodiments, delineating characters, such as spaces, plus signs, and semicolons may be included in the query string for separating the terms in the search query. By way of example, the query string may comprise “1989+Chrysler+LeBaron+reviews” and the entire query may be sent to the searchable means associated with the selected tab. A search of the searchable means may generally return a list of search results to the SPE 140. The list of search results may comprise, for example, a social media website review, a social media website mention, a video review, an audio review, and a custom review, or the like.

The list of search results returned to the SPE 140 may comprise Google reviews, YouTube video reviews, Twitter mentions, Facebook pages/groups/mentions, or the like, which will be displayed to the user to aid in his or her purchase decision. The SPE 140 may be configured to return a certain number of top reviews. By way of example, number of top reviews may comprise the top 10/20/30 results, or the like. The results may be displayed in a results window. The results window may be displayed on at least one of the plurality of tabs 150 of the user interface 102 or may be displayed in a pop-up display 130. In accordance with exemplary embodiments, a pop-up display 130 may comprise a new process and/or window that pops up in front of the product website 108. The SPE 140 may be configured to allow the user to access results within the results window. The results window may further comprise host/product website branding and a visible close means, such as a close button (not shown) to return the user to the host website. In some embodiments, an additional search term, such as “reviews” may not be included in the query string and the query string may comprise just the product identification data. The product identification data may comprise only a single term, such as “Chrysler” or “LeBaron,” or may comprise multiple terms. In some embodiments, the SPE 140 may be interfaced with a website such as a social networking website via an application programming interface (API). When the SPE 140 is interfaced with Facebook via an API, for example, the SPE 140 may be configured to display the most relevant Facebook product/topic pages and groups to the user. In some embodiments, the SPE 140 may be configured to display a mix of specific “favorite” videos selected and/or created by the host and/or SA to be displayed to the user. The SPE 140 may be configured to assign favorite videos or may be configured to assign a specific view state. In different view states, the favorite videos may be viewed all products or may be viewed only with selected products. After the results are displayed by the SPE 140, the user may decide to display a second set of search results by initiating a search of a second searchable means by selecting a second tab using the methods described above.

In exemplary embodiments, when a second tab is selected, second query string may be formed by combining the product identification data with a second search term associated with a second tab selection. The second query string may be sent to a second searchable means and/or search server and a second list of search results may be received by the SPE 140 from the second searchable means and/or search server, wherein the second list of search results is gathered by the second searchable means and/or search server after running a search of the second query string. After the second list of search results is received it may be sent to the client 105 for display at step 850. After the first list of search results and/or additional lists of search results are generated, they may be displayed simultaneously or in separate tabs in a results display and/or in one or more pop-up display windows.

At step 850, the search results are received by the SPE 140 and displayed by the client 105. The list of search results may be displayed in a results list fashion, just as they would on the originating websites/platforms/searchable means. In alternative embodiments, the SPE 140 may be configured to display the list of search results in a customized fashion that is different from the way they would be displayed on the originating websites/platforms/searchable means. In exemplary embodiments, the list of search results may be displayed simultaneously on in the same results window display or may be displayed from only one source at a time. The results window may comprise a branding display portion for displaying branding information, such as company logos, slogans, trademarks, videos, animations, audio jingles, or the like. After the user has completed selecting one or more tabs and interacting with and/or viewing the search results, the results window display can be closed, returning to user to the originating website where they can continue interacting with the widget or make contact with the host company trough the product website 180. The method 800 ends at step 860.

While the foregoing is directed to embodiments of the present disclosure, other and further embodiments of the disclosure may be devised without departing from the basic scope thereof. It is also understood that various embodiments described herein may be utilized in combination with any other embodiment described, without departing from the scope contained herein. In addition, embodiments of the present disclosure are further scalable to allow for additional clients and servers, as particular applications may require.

What is claimed is:

1. A computer-implemented method for integrating product data on a product website, the method comprising:
at a client having one or more processors and memory storing one or more programs for execution by the one or more processors:
displaying a user interface on the product website, the user interface comprising a plurality of tabs;
receiving a tab selection indicating at least one tab of the plurality of tabs;
retrieving product identification data;
forming a query string by combining the product identification data with a search term associated with the tab selection;
sending the query string to a server;
receiving a list of search results from the server, wherein the list of search results is gathered by the server after running a search of the query string; and
displaying the list of search results in a results window displayed over the product website.

2. The method of claim 1, further comprising:
receiving a second tab selection indicating a second tab of the plurality of tabs;
forming a second query string by combining the product identification data with a second search term associated with the second tab selection;
sending the second query string to the server;
receiving a second list of search results from the server, wherein the second list of search results is gathered by the server after running a search of the second query string; and
displaying the second list of search results in the results window.

3. The method of claim 2, wherein all lists of search results are displayed simultaneously.

4. The method of claim 1, wherein results window comprises a branding display portion for displaying branding information.

5. The method of claim 1, wherein the tab selection comprises an indication received via at least one of mouse click selection and a touch-screen selection of one of the plurality of tabs by a user.

6. The method of claim 1, wherein the product identification data is retrieved by performing a text search of the product website and locating the product identification data by comparing the scanned text to a database of recognized product identification terms, wherein when a match between a portion of the scanned text and at least one of the recognized product identification terms occurs, the matching portion is designated as product identification data.

7. The method of claim 1, wherein the product identification data comprises at least one of a manufacturer name, a model name, and a year of manufacture.

8. The method of claim 1, wherein the list of search results comprises at least one of a social media website review, a social media website mention, a video review, an audio review, and a custom review.

9. A computer-implemented method for integrating product data on a product website displayed on a client, the method comprising:
at a server having one or more processors and memory storing one or more programs for execution by the one or more processors:
sending for display by the client, a user interface on the product website, the user interface comprising a plurality of tabs;
receiving a query string from the client, the query string formed by combining product identification data with a search term associated with a tab selection;
sending the query string to a search server;
receiving a list of search results from the search server, wherein the list of search results is gathered by the search server after running a search of the query string; and
sending the list of search results to the client for display in a results window displayed over the product website.

10. The method of claim 9, further comprising:
receiving a second query string from the client, the second query string formed by combining the product identification data with a second search term associated with a second tab selection;
sending the second query string to a second search server;
receiving a second list of search results from the second search server, wherein the second list of search results is gathered by the second search server after running a search of the second query string; and
sending the second list of search results to the client for display in the results window displayed over the product website.

11. The method of claim 10, wherein all lists of search results are displayed simultaneously.

12. The method of claim 9, wherein the tab selection comprises an indication received via at least one of mouse click selection and a touch-screen selection of one of the plurality of tabs by a user.

13. The method of claim 9, wherein the product identification data is retrieved by performing a text search of the product website and locating the product identification data by comparing the scanned text to a database of recognized product identification terms, wherein when a match between a portion of the scanned text and at least one of the recognized product identification terms occurs, the matching portion is designated as product identification data.

14. The method of claim 9, wherein the product identification data comprises at least one of a manufacturer name, a model name, and a year of manufacture.

15. The method of claim 9, wherein the list of search results comprises at least one of a social media website review, a social media website mention, a video review, an audio review, and a custom review.

16. A system comprising at least one server, the server comprising:
one or more processors; and
memory;
wherein the at least one server is configured to:
send for display by a client, a user interface on a product website, the user interface comprising a plurality of tabs;
receive a query string from the client, the query string formed by combining product identification data with a search term associated with a tab selection;
send the query string to a search server;
receive a list of search results from the search server, wherein the list of search results is gathered by the search server after running a search of the query string; and
send the list of search results to the client for display in a results window displayed over the product website.

17. The method of claim 16, wherein the at least one server is further configured to:
receive a second query string from the client, the second query string formed by combining the product identification data with a second search term associated with a second tab selection;
send the second query string to a second search server;
receive a second list of search results from the second search server, wherein the second list of search results is gathered by the second search server after running a search of the second query string; and
send the second list of search results to the client for display in the window displayed over the product website.

18. The method of claim 16, wherein the tab selection comprises an indication received via at least one of mouse click selection and a touch-screen selection of one of the plurality of tabs by a user.

19. The method of claim 16, wherein the product identification data comprises at least one of a manufacturer name, a model name, and a year of manufacture.

20. The method of claim 16, wherein the list of search results comprises at least one of a social media website review, a social media website mention, a video review, an audio review, and a custom review.
